(19) United States
(12) Patent Application Publication
(10) Pub. No.: US 2004/0213081 A1
(43) Pub. Date: Oct. 28, 2004

(54) Method and device for compacting thermoplastic material

(76) Inventors: Johannes Wissing, Stadtlohn (DE); Heinrich Wissing, Vreden (DE); Heinz Rainer Schnettler, Bornheim (DE)

Correspondence Address: STEVEN P. ARNHEIM, SHAW PITTMAN LLP, 1650 TYSONS BOULEVARD, MCLEAN, VA, 22102, US

(21) Appl. No.: 10/736,604

(22) Filed: Dec. 17, 2003

(30) Foreign Application Priority Data
Dec. 18, 2002 (DE) 10259102.4

(51) Int. Cl. B01F 7/00

(52) U.S. Cl. 366/286

(57) ABSTRACT

A compactor for the preparation of thermoplastic materials placed between two approximately disc-shaped work surfaces at least one of which is rotatably connected to a rotary driven drive shaft and to a rotatable work surface and to a sleeve that surrounds the drive shaft, which can be operated axially with the drive shaft, whereby the sleeve is fitted with an exterior screw thread, wherein the sleeve cannot rotate, and wherein the sleeve is surrounded on its exterior by a rotatably mounted component that by means of an interior screw thread meshes with the exterior screw thread on the sleeve, whereby the rotatably mounted component is capable of operation in two directions by means of a driving mechanism.

This application claims the benefit of German Patent Application No. 10259102.4, filed Dec. 18, 2002, which is herein incorporated by reference in its entirety.

### BACKGROUND

1. Field of the Invention

The present invention relates generally to a method and a device for compacting thermoplastic materials, and more particularly to a compactor with a displaceable sleeve.

2. Background of the Invention

Compactors for compacting thermoplastic materials, also known as plastic compactors, disc compactors, or agglomerators, are used for plastic recycling purposes. The compaction is achieved by tremendous pressure, friction and kneading of the plastic waste. Important materials that are reprocessed using such machines are all types of film waste made from thermoplastic materials, expanded plastic materials made from polyethylene or polystyrene, carpet waste made from polyamide or polypropylene as well as fiber waste such as woven and non-woven material, man-made fibers and synthetic resin fibers, made from polyesters, polypropylene or polyamide. This technique is above all used for reprocessing clean and sorted commercial waste. In the past few years, compactors have more and more often also been employed for consumer waste. The product resulting from the process is known as compacted material or agglomerate. The compressing process using compactors is described in, for example, the magazine KUNSTSTOFFE 80 (1990) 4 on pages 499 to 501.

Plastic material could, for example, be placed in between the two approximately disc-shaped work surfaces and the relative movement of the two work surfaces against each other warms and works the plastic material so that thin-walled film materials to be ground, fibers and expanded plastic materials are formed into a compact material with high bulk density. Usually, a stationary work surface, called a stator, and a rotating work surface, called a rotor, is used, however, it is also possible to use work surfaces with different rotational frequency and/or different rotational direction.

The distance between the two work surfaces must regularly be reduced or increased depending on the type of compactor used to achieve the optimal operational setting point. The optimal setting point is achieved when the material temperature lies below the melting temperature but above the softening temperature. Additional parameters that characterize an optimal operational setting point include a high bulk density of the compact material and high compactor throughput.

As an example, a parameter that requires frequent changing of the distance between the stator and the rotor will be described in further detail. The temperature of the plastic material positioned between the work surfaces should not be so high that the plastic melts and becomes fluid and thus sticky. An operating condition in which the plastic is sticky must be avoided at all cost. If this happens, the plastic will stick together and the material accumulates after removal from the work surfaces. In this scenario, the necessary pneumatic transportation of the compacted plastic is no longer possible. A parameter suitable for influencing the temperature of the plastic is the distance between the stator and the rotor. When the distance between the work surfaces is large, the frictional energy achieved is lower than when the distance is smaller. Thus far, it has not been possible to measure the temperature of the plastic material placed in between the two work surfaces. Therefore, to regulate the process a guiding temperature is chosen. To this end, the temperature of the stator is suitable since it can be determined with little effort. The stator temperature is approximately proportional to the temperature of the plastic material placed in between the discs. Thanks to improved regulation techniques using efficient and cheap programmable logic control, the gap between the discs is continually controlled so that the default optimal material temperature is maintained while throughput remains as high as possible. To this end, it is furthermore necessary to employ an efficient, non-sensitive displacement mechanism, which is a need addressed by the present invention.

In practice, comparably smaller compactors are used for this purpose, which axially shift the rotary driven work surface together with its drive shaft. Such a device is described in, for example, DE-A-1454875. The disadvantage of that device is the axial displacement mechanism that displaces the disc gap to correspond to the optimal operation setting point.

FIG. 2 shows a device in accordance with the prior art described above. The drive shaft 13 is rotatable and is held in a basically stationary housing 14 whereby a sleeve 15 is fitted between the housing wall and the drive shaft. Within the sleeve 15, the drive shaft 13 rotates freely. The sleeve 15 meshes with an interior screw thread of the housing 17 by means of an exterior screw thread 16.

As the sleeve 15 is rotated by the worm 19, the thread meshing 16, 17 forces the sleeve to an axial movement within the housing 14. As opposed to the continuously rotating drive shaft 13 the sleeve 15 is only rotated as needed namely as the sleeve 15 is axially displaced and therefore also the rotating work surface 18.

This rotational movement of the sleeve occurs by means of a worm gear. To achieve this, a worm 19 is tangentially mounted onto the sleeve 15 whereby corresponding gear teething 20 is fitted on the exterior of the sleeve that mesh with the gear teething 19 on the worm. The axes of worm 19 and sleeve 15 are placed at a 90° angle to each other. The concave shaped teething that enables large surface contact with the worm is not possible because of the desired axial movement of the sleeve. Therefore, a very small surface, almost spotty, contact occurs between the worm and the gear teething fitted onto the surface of the sleeve. However, this leads to undesirably rapid wear of the gear teething on the sleeve and to metallic abrasion. Such metallic abrasion reaches the bearings 20 and 21 of the drive shaft 13 where it causes damage and finally the destruction of the bearings 20 and 21. A further disadvantage is the complex and thus expensive manufacture of the sleeve 15 and the housing 14.

### BRIEF SUMMARY OF THE INVENTION

It is therefore the object of the present invention to provide a compactor with a displacement mechanism that significantly improves the prior art devices and, in particular, that works while causing less wear whereby the components should consist of standardized parts that are available at reasonable prices on the machine parts market.

An embodiment of the present invention proposes that the displacement occurs, as before, by means of an axial shifting of the sleeve; however, this does not occur by means of a rotational movement of the sleeve but rather the sleeve in accordance with an embodiment of the present invention is not rotatable and can merely be shifted in an axial direction. In contrast to the typical constructions of this type, the seal between the drive shaft, sleeve, and housing is thus simplified. In accordance with an embodiment of the present invention, the displacement of the sleeve occurs by means of screw thread teething whereby the exterior screw thread is fitted on the outside of the sleeve and an outside component, for example an outer ring, is fitted with the corresponding interior screw thread on the interior surface. In connection with the present invention, “screw thread” means a complementary shape that, depending on the rotational movement of one component, generates an axial shifting of the other component. Such a “screw thread” can also be realized without using several thread dials, for example by using a bayonet locking-like link motion. The axial displacement of the sleeve occurs as the outside component described above which is mounted in an axial direction is rotated so the sleeve can be shifted forwards or backwards as desired depending on the rotational direction of the outside component. Preferably, a housing surrounds the drive shaft, the sleeve, and also the rotatable outside component to protect them. An example of an embodiment of the present invention employs a worm and a worm gear wheel, which offers an optimal gear mesh because it does not wear easily.

A considerably more complicated construction such as the radial exterior placement of one of the two work surfaces and a displacement of these work surfaces can be avoided if the sleeve can be shifted allowing that, all together, the advantages of a simple and cheaper construction can be realized.

Preferably, the outside component is ring-shaped. In other words, the outside component is a relatively narrow component so that a comparably smaller space is required for this assembly.

The rotational drive for the outside component such as a ring as mentioned above can grip on its outer perimeter, for example, by means of corresponding gear teething onto the exterior of the rotatable component such as a worm gear. Since the outside component, which, for example, could be ring-shaped, is not shifted in an axial direction, the worm drive could be fitted with large surface contact areas between worm and gear teething. Concave shaped gear teething on the rotatable component would, for example, be suitable so that in comparison with other typical constructions of the same type significantly less stress of these drives occurs than is otherwise the case for similar underlying conditions and correspondingly the operating safety and life span of the proposed construction are improved. It is possible to, in lieu of the worm drive, use gear wheel or chain gear driving mechanisms on the outside component so that depending on what is required, either a particularly affordable, a particularly compact, or a particularly low maintenance construction can be chosen.

Alternatively, the driving mechanism can grip onto the end side of the exterior rotatable component, for example, by means of a spur gear or bevel gear drive. If there is only little radial space available around the rotatable outside component for a driving mechanism, radial space around the rotatable outside component could be saved by using such end side power transfer.

### BRIEF DESCRIPTION OF THE DRAWINGS

FIG. 1 is a schematic drawing showing a detail of a section of the transitional area leading from the drive shaft to the rotatable compactor work surface, in accordance with an embodiment of the present invention.

FIG. 2 a schematic view of a section of a prior art compactor.

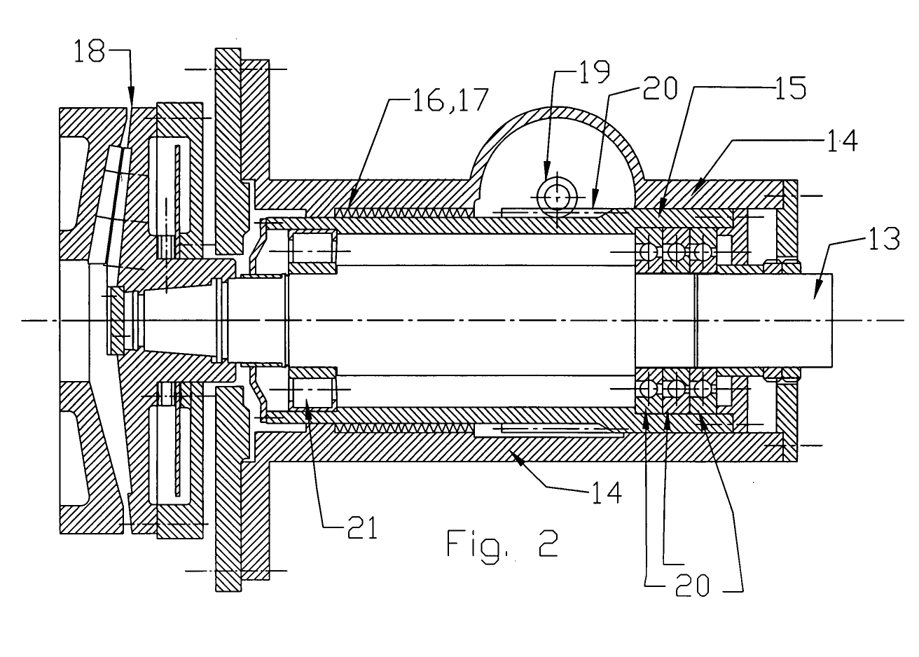

### DETAILED DESCRIPTION OF THE INVENTION

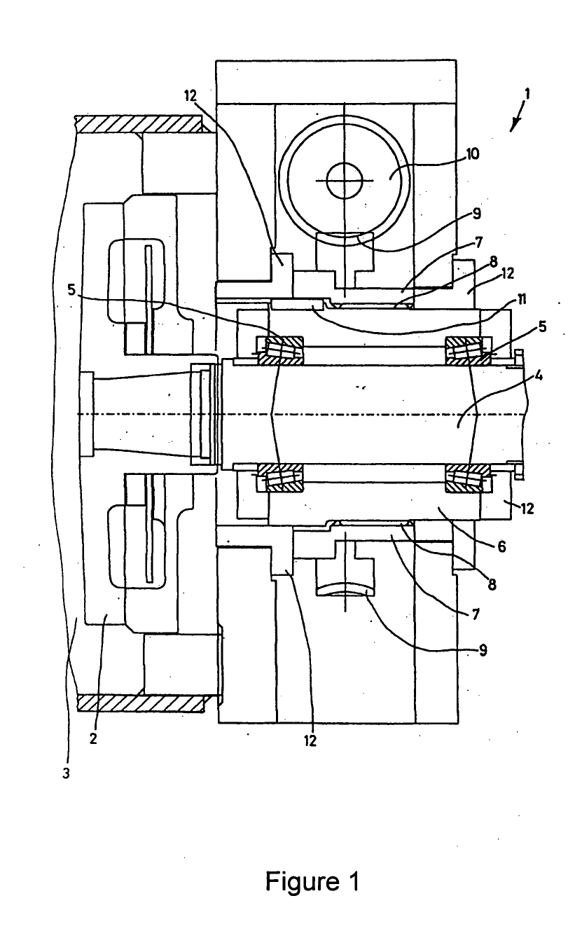

In FIG. 1, number 1 generally denotes a compactor, only some details of which are shown.

In this manner, for example, a rotatable work surface 2 is shown while the corresponding stator is not shown. The work surface 2 is arranged within a compaction chamber 3 and is rotationally driven by means of a drive shaft 4.

The drive shaft 4 is rotationally mounted inside the sleeve 6 by means of a tapered roller bearing 5. The sleeve 6 having a merely insinuated screw thread 8 meshes with a rotatable outside ring-shaped component 7. This component 7 is fitted with concave shaped driving gear teething 9. By means of a worm 10, the outside component 7 is thus rotated. Since the outside component 7 is attached at both axial ends and therefore cannot be shifted in either axial direction, an axial displacement of the sleeve 6 occurs as this component 7 is rotated because of the rising thread pitch of the screw thread 8.

The sleeve 6 is fitted within an exterior housing 12 by means of a feather key 11 and cannot rotate. In this manner, the rotation of the outside component 7 is transferred to produce the axial movement of the sleeve 6 by means of the screw thread 8. In this process, the sleeve 6 moves the drive shaft 4 with it in an axial direction so that a displacement of the rotatable work surface 2 occurs in an axial direction by means of the drive shaft 4.

A particular advantage of this embodiment is the line contact teeth meshing that the worm 10 forms with the worm wheel gear teething 9. As opposed to the theoretical spotty teething mesh of the displacing mechanism disclosed in DE-A-1454875, the contact area is significantly larger and the material stress and the metallic abrasion are thus minimized, which significantly increases the lifespan of the gear teething and the bearing and thus the entire gear construction.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A compactor for preparation of thermoplastic material comprising:
an approximately disc-shaped work surface rotatably connected to a rotary driven drive shaft and to a sleeve that surrounds the drive shaft, which can be operated in an axial direction with the drive shaft, whereby the sleeve is fitted with an exterior screw thread,
wherein the sleeve cannot rotate, and
wherein the sleeve is surrounded on its exterior by a rotatably mounted component that by means of an interior screw thread meshes with the exterior screw thread on the sleeve, whereby the rotatably mounted component is capable of operation in two directions by means of a driving mechanism.

2. The compactor of claim 1, wherein the rotatably mounted component is ring-shaped.

3. The compactor of claim 1, wherein the rotatably mounted component on its outer perimeter is suitable for connection with the driving mechanism by means of gear teething for one of a worm gear, gear wheel, and chain gear.

4. The compactor of claim 2, wherein the rotatably mounted component on its outer perimeter is suitable for connection with the driving mechanism by means of gear teething for one of a worm gear, gear wheel, and chain gear.

5. The compactor of claim 1, wherein the rotatably mounted component on an axial end face is suitable for connection with the driving mechanism by means of gear teething for one of spur gears and bevel gear wheels.

6. The compactor of claim 2, wherein the rotatably mounted component on an axial end face is suitable for connection with the driving mechanism by means of gear teething for one of spur gears and bevel gear wheels.
